(19) United States
(12) Patent Application Publication
(10) Pub. No.: US 2023/0105999 A1
(43) Pub. Date: Apr. 6, 2023

(54) FUNCTIONAL MASK

(71) Applicants: Se ran KIM, Wonju-si (KR); 3R-Company CO., LTD., Wonju-si (KR)

(72) Inventor: Se ran KIM, Wonju-si (KR)

(21) Appl. No.: 17/523,156

(22) Filed: Nov. 10, 2021

(30) Foreign Application Priority Data
Oct. 6, 2021 (KR) 10-2021-0132326

(51) Int. Cl. A41D 13/11

(52) U.S. Cl. CPC A41D 13/113

(57) ABSTRACT

A present invention relates to a functional mask that prevents health problems such as skin problems and bacterial growth caused by internal moisture due to a wearer's exhaled breath by providing an improved structure having an air passage filter. The present invention discloses a functional mask comprising: a first outer layer covering the mouth and nose of the face of a wearer; a second outer layer connected to an ear string, and a filtering inner layer integrally connecting the first outer layer and the second outer layer, wherein an air passage part is formed by a folded structure of the filtering inner layer, thereby allowing an exhaled breath of the wearer to be discharged through the air passage part from the functional mask.

### FIELD OF THE INVENTION

The present invention relates to a functional mask, and more particularly to a functional mask that prevents health problems such as skin problems and bacterial growth caused by internal moisture due to a wearer's exhaled breath by providing an improved structure having an air passage filter.

### BACKGROUND OF THE INVENTION

In general, a mask covers the wearer's respiratory tract, such as the nose or mouth, in order to prevent airborne germs or dust from being inhaled into the human body, or to prevent germs and viruses coming from one's respiratory tract from transferring to other people or objects.

A conventional mask has a structure of a cover and a string connected to each other. The cover covers the nose and mouth, and the string may be earloops hung on the ears or a fixing cord tied behind the head.

The conventional mask mentioned above may be a mask disclosed in Patent Document 1, which is suggested to block harmful substances, yellow dust, fine dust, and the like. However, conventional masks simply serve to cover the mouth and nose, and thus do not properly filter harmful substances. In addition, the mask according to Patent Document 1 has a relatively heavy weight and large volume in order to properly perform filtering function. Accordingly, although the mask can properly filter harmful substances, it is not useful in daily lives. Therefore, it is necessary to develop a mask that can properly filter harmful substances and reduce the production cost, while having great portability and wearing comfortability.

### PRIOR ARTS

### Patent Document

(Patent Document 0001) Korean Patent Registration No. 10-1647930
(Patent Document 0002) Korean Utility Model Registration No. 20-0222893

### Technical Problem

Therefore, an object of the present invention for solving the conventional problems as described above is to provide a functional mask that prevents health problems such as skin problems and bacterial growth caused by internal moisture due to a wearer's exhaled breath.

Another object of the present invention is to provide a functional mask that inhibits bacterial growth and protects skin from internal moisture with an air passage through which the wearer's exhaled breath is discharged to the outside to prevent exhaled breath from returning to the face.

Another object of the present invention is to provide a functional mask that inhibits bacterial growth and improves health problems such as skin problems by providing a gill-shaped filtering part that serves as an air passage on the left and right side of the mask to quickly remove the wearer's exhaled breath and reduce internal humidity.

Another object of the present invention is to provide a functional mask with a gill-shaped filtering part that serves as an air passage on the left and right sides of the mask so that air quickly escapes through the left and right filtering part during exhalation, and the inflow of fine dust is blocked by air resistance of the gill-shaped filtering part during inhalation.

### SUMMARY OF THE INVENTION

To achieve the objects mentioned above, the present invention discloses a functional mask comprising: a first outer layer covering the mouth and nose of the face of a wearer; a second outer layer connected to an ear string, and a filtering inner layer integrally connecting between the first outer layer and the second outer layer, wherein an air passage part is formed by a folded structure of the filtering inner layer, thereby allowing an exhaled breath of the wearer to be discharged through the air passage part from the functional mask.

The folded structure may be formed by the filtering inner layer folded in a “Z” shape structure that connects between the first and second outer layer, and the filtering inner layer folded in the “Z” shape structure forms the air passage part on a right side and a left side of the functional mask.

Each of the first outer layer and the second outer layer may be provided as a single piece, respectively,

The filtering inner layer may have a “Z” shape structure in which each of one end and the other end of the filtering inner layer is folded, respectively,

Integral connections between the filtering inner layer and the first outer layer and between the filtering inner layer and the second outer layer may form the air passage part on a right side and a left side of the functional mask.

A portion on which the filtering inner layer and the first and second outer layer may be overlapped is a double-layered structure, and the filtering inner layer is a single-layer structure.

The first and the second outer layer may be made of 99.9% antibacterial copper yarn.

The filtering inner layer may comprise a nano-fabric filter.

The first outer layer is formed as a single piece, and the second outer layer is formed as a pair of a right and a left piece, wherein the filtering inner layer formed as a single piece integrally connects between an inner side of the first outer layer and an inner side of the second outer layer and thus forms the single functional mask.

### Advantageous Effects

The present invention provides a functional mask that can prevent health problems such as bacterial growth and skin problems caused by internal moisture due to the wearer's exhaled breath.

In addition, the present invention provides a functional mask that can inhibit bacterial growth and protect skin from internal moisture by forming an air passage through which the wearer's exhaled breath is discharged to prevent exhaled breath from returning to the face.

Furthermore, the present invention provides a functional mask that can inhibit bacterial growth and improve health problems such as skin problems by providing a gill-shaped filtering part that serves as an air passage to quickly remove the wearer's exhaled breath and reduce internal humidity.

Moreover, the present invention provides a functional mask with a gill-shaped filtering part that can serve as an air passage so that air quickly escapes through a left and right filtering part during exhalation, and the inflow of fine dust is blocked by air resistance of the gill-shaped filtering part during inhalation.

In addition, the present invention provides a functional mask that can omit a separate filter means by forming a mask with a filtering part as a single body. The filtering part formed by connecting one outer layer and the other outer layer can be easily adopted in a conventional mask. Accordingly, the present invention can reduce the production cost and increase the efficiency of production.

### BRIEF DESCRIPTION OF THE DRAWINGS

FIGS. 1 to 5 are embodiments illustrating a functional mask according to the present invention.

FIG. 1 is a front perspective view of a functional mask according to the present invention.

FIG. 2 is a rear perspective view of a functional mask according to the present invention.

FIG. 3 is an exploded perspective view of a functional mask according to the present invention.

FIG. 4 is an exemplified planar view of a functional mask according to the present invention.

FIG. 5 is an exemplified drawing illustrating air flow according to a main component of the present inventio

FIG. 6 is an exemplified magnified cross-section view illustrating an air passage part, which is a main component of a functional mask, according to the present invention.

### DETAILED DESCIPTION EMBODIEMENTS OF THE INVENTIONS

Some specific embodiments of the present invention will be illustrated in the drawings and described in detail. However, it is not intended to limit the present invention to the certain embodiments. The present invention should be understood to include all modifications, equivalents, or substitutes within the spirit and scope of the present invention.

The present invention is not limited to the embodiments disclosed below, and may be embodied in various different forms. The described embodiments are provided to completely disclose of the present invention and to convey the scope of the invention to one of ordinary skill in the art.

Hereinafter, preferred embodiments of the present invention will be described in detail with reference to the accompanying drawings. First of all, in adding reference numbers corresponding to components shown in each drawing, the same components are denoted by the same reference numbers as much as possible even though they are used on different drawings. In addition, in describing the present invention, if detailed description of the known configuration or function related to the present invention obscures the gist of the present invention, the detailed description thereof will be omitted.

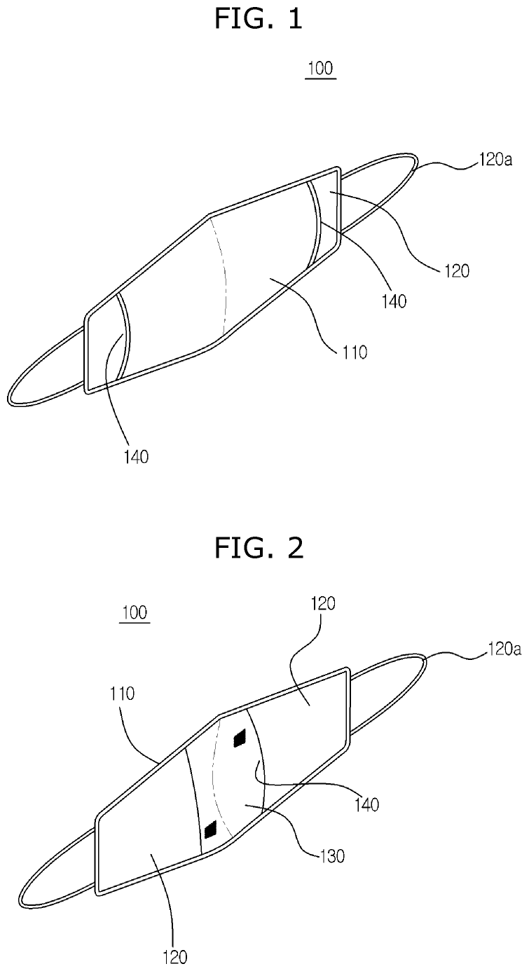

FIGS. 1 to 5 are embodiments illustrating a functional mask according to the present invention.

Referring to FIGS. 1 to 6, a functional mask 100 according to the present invention comprises a first outer layer 110 covering the mouth and nose of the face of a wearer; a second outer layer 120 connected to an ear string 120a, and a filtering inner layer 130 integrally connecting between the first outer layer 110 and the second outer layer 120, wherein an air passage part 140 is formed by a folded structure of the filtering inner layer 130, thereby allowing an exhaled breath of the wearer to be discharged through the air passage part 140 from the functional mask 100.

The first outer layer 110 is a single-piece component positioned at the front side of the functional mask 100 and corresponding to the position of the mouth and nose of the wearer. The first outer layer 110 may be made of 99.9% antibacterial copper yarn corresponding to fine dust, yellow sand, and the like.

In addition, the first outer layer 110 may be made of copper yarn having a virus blocking function and a droplet blocking function. In other embodiments, the first outer layer 110 may be made of a fabric that absorbs and dries quickly, and/or a spandex fabric to ensure comfortability of the wearer.

The second outer layer 120 is a single pair of pieces positioned on the left side and right side of the functional mask 100 and is in contact with the wearer's facial contact part S of the face. An ear string 120a hung on the wearer's ear may be positioned at one end of the second outer layer 120.

Preferably, the first outer layer 110 is formed as a single piece, the second outer layer 120 is formed as a pair of a left and a right piece, and the filtering inner layer 130 formed as a single piece integrally connects between the inner side of the first outer layer 110 and the inner side of the second outer layer 120, thereby forming the single functional mask 100.

The filtering inner layer 130 may be configured to have air passage parts 140 on both sides of the functional mask 100. The air passage part 140 may be formed by a gill-shaped filter structure of the filtering inner layer 130, which integrally connects between the first and second outer layer 110, 120.

In this instance, the air passage part 140 formed by the filtering inner layer 130 may be configured to allow the wearer's exhaled breath to be discharged through the air passage part 140.

In addition, the filtering inner layer 130 may be a nano-fabric filter that can easily respond to fine dust, yellow sand, and the like. In other embodiments, the functional mask 100 may increase wearing comfortability of the wearer by forming the filtering inner layer 130 with fabric capable of quick absorbing and drying, or spandex fabric.

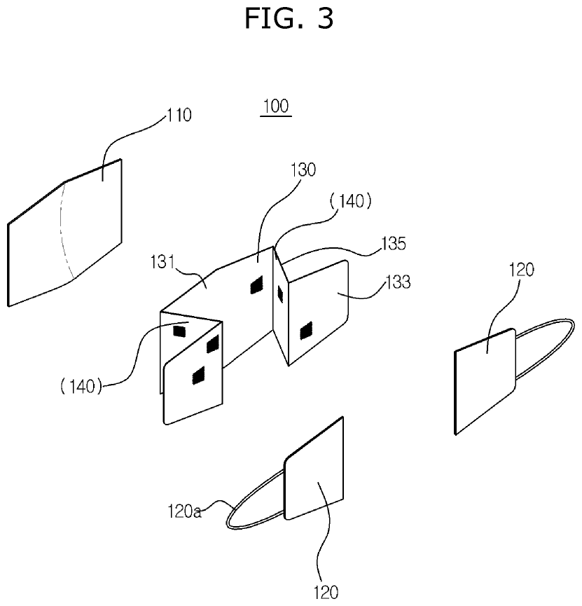

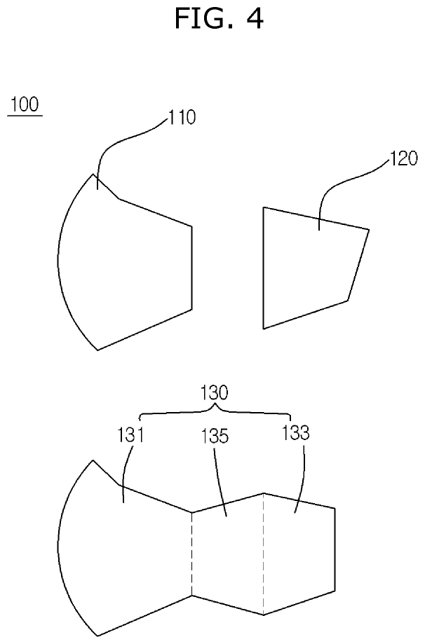

Referring to FIGS. 3 to 4, each of the first outer layer 110 and the second outer layer 120 is provided as a single piece, respectively. The filtering inner layer 130 is provided to comprise a front side part 131 meeting with the first outer layer 110; a rear side part 133 meeting with the second outer layer 120 at the rear thereof, and an extension part 135 connecting between the front side part 131 and the rear side part 133 and folded in a “Z” shape allowing to form an air passage space inside The first and the second outer layer 110, 120 and the filtering inner layer 130 integrally connected to each other form the air passage part 140 on both sides of the functional mask 100.

In other words, a portion on which the filtering inner layer and the first and second outer layer are overlapped is a double-layered structure, and the filtering inner layer is a single-layer structure. Specifically, a portion on which the filtering inner layer 130 and each of the first and second outer layer 110, 120 are combined with each other is a double-layered structure, and the filtering inner layer 130 which the air passage part 140 is formed around is a single-layer structure.

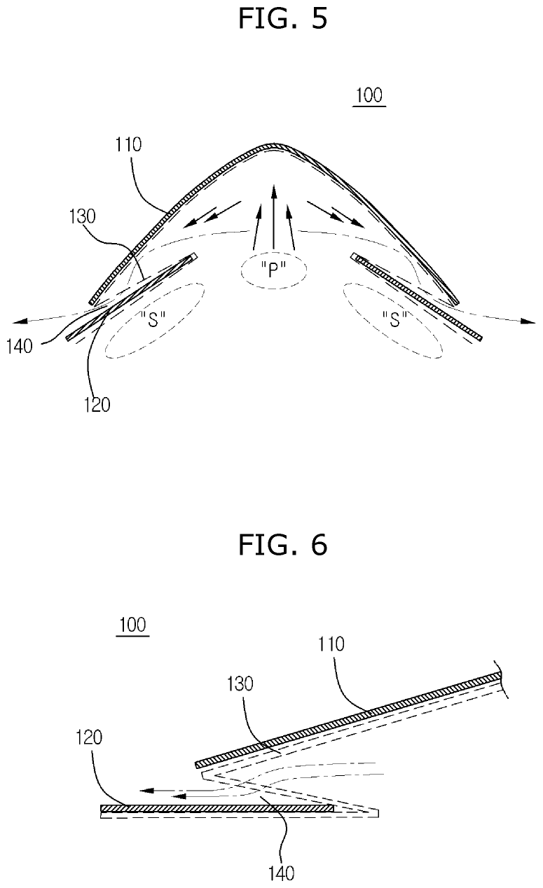

The air passage part 140 will be described in more detail with reference to FIGS. 5 to 6 as below.

The filtering inner layer 130 folded in a zigzag “Z” shape structure in a gill shape forms the air passage part 140 on the folded zigzag area by combining with the first and second outer layer 110, 120. The air passage part 140 on the folded zigzag area allows the wearer's exhaled breath to be quickly discharged through the right and the left air passage part 140 of the functional mask 100, thereby providing a moisture blocking function on the face of the wearer.

In other words, when the wearer exhales, the air that collides with the facial center part P quickly exits through the left and right air passage part 140. When the wearer inhaled, the air passage part 140 can block the inflow of external air due to air resistance. In this instance, the filtering inner layer 130 is preferably made of a fabric that can pass air smoothly, which does not need cutting on any area of the functional mask 100.

In addition, the second outer layer 120 in contact with the facial contact part S provides a partition function to block moisture in exhaled breath returning to the facial center part P, thereby reducing the humidity of the face. Accordingly, the functional mask 100 can reduce skin problems caused by wearing for a long time, and also prevent spreading of various harmful bacteria by quickly removing internal moisture through the left and right air passage part 140, thereby providing wearing comfortability in long-term use and allowing the wearer to enjoy outdoor activities and sports activities.

As described above, the present invention provides a “Z”-shaped filtering part in which an air passage part in the form of a hole is formed. As mentioned above, the “Z”-shaped filtering part uses the double-layered structure in which the outer layer and the inner layer are overlapped. This structure using the air passage part 140 and the outer layer meeting with the face can protect skin from moisture and lower sensory temperature by blocking exhaled breath from returning to the facial contact part S of the face. In addition, a gill-shaped filtering part can inhibit bacterial growth and improve health problem such as skin problems by quickly removing exhaled breath and reducing internal humidity.

Although the present invention has been illustrated and described with reference to preferred embodiments as described above, it is not limited to the embodiments described above, and various modifications and variations are possible within the scope of equivalents of the claims.

What is claimed is:

1. A functional mask comprising:
a first outer layer covering the mouth and nose of the face of a wearer;
a second outer layer connected to an ear string, and
a filtering inner layer integrally connecting between the first outer layer and the second outer layer,
wherein an air passage part is formed by a folded structure of the filtering inner layer, thereby allowing an exhaled breath of the wearer to be discharged through the air passage part from the functional mask.

2. The functional mask of claim 1, wherein the folded structure is formed by the filtering inner layer folded in a “Z” shape structure that connects between the first and second outer layer, and the filtering inner layer folded in the “Z” shape structure forms the air passage part on a right side and a left side of the functional mask.

3. The functional mask of claim 1, wherein each of the first outer layer and the second outer layer is provided as a single piece, respectively,
wherein the filtering inner layer has a “Z” shape structure in which each of one end and the other end of the filtering inner layer is folded, respectively,
wherein integral connections between the filtering inner layer and the first outer layer and between the filtering inner layer and the second outer layer form the air passage part on a right side and a left side of the functional mask.

4. The functional mask of claim 1, wherein a portion on which the filtering inner layer and the first and second outer layer are overlapped is a double-layered structure, and the filtering inner layer is a single-layer structure.

5. The functional mask of claim 1, wherein the first and the second outer layer is made of 99.9% antibacterial copper yarn.

6. The functional mask of claim 1, wherein the filtering inner layer comprises a nano-fabric filter.

7. The functional mask of claim 1, wherein the first outer layer is formed as a single piece, and the second outer layer is formed as a pair of a right and a left piece,
wherein the filtering inner layer formed as a single piece integrally connects between an inner side of the first outer layer and an inner side of the second outer layer and thus forms the single functional mask.
